(19) United States
(12) Patent Application Publication
(10) Pub. No.: US 2026/0120676 A1
(43) Pub. Date: Apr. 30, 2026

(54) METHOD OF GENERATING SPEECH DATA BASED ON LARGE MODEL AND METHOD OF TRAINING LARGE MODEL

(71) Applicant: BEIJING BAIDU NETCOM SCIENCE TECHNOLOGY CO., LTD., Beijing (CN)

(72) Inventors: Xiaoyin FU, Beijing (CN); Qiguang ZANG, Beijing (CN); Fenfen SHENG, Beijing (CN); Xing NIE, Beijing (CN); Tao SUN, Beijing (CN); Guibin WANG, Beijing (CN); Bin HUANG, Beijing (CN); Lei JIA, Beijing (CN)

(21) Appl. No.: 19/425,162

(22) Filed: Dec. 18, 2025

(30) Foreign Application Priority Data
Nov. 5, 2025 (CN) 202511612500.5

(51) Int. Cl. G10L 13/10; G06N 20/00; G10L 13/027

(52) U.S. Cl. CPC G10L 13/10; G06N 20/00; G10L 13/027

(57) ABSTRACT

A method of generating speech data based on a large model and a method of training a large model are provided, which relate to artificial intelligence technology, in particular to fields of speech generation, intelligent customer service, video production, etc. The method includes: receiving prosodic description text and speech text, where the prosodic description text describes pronunciation prosodic intentions for text characters in the speech text; performing semantic fusion on the prosodic description text and the speech text using the large model, to obtain a prosodic fusion feature, where a sub-feature in the prosodic fusion feature characterizes a pronunciation prosody of a speech segment with respect to the text characters; and generating, based on the prosodic fusion feature and a specified pronunciation attribute associated with a specified object, target speech data characterizing that the specified object pronounces in accordance with the pronunciation prosodic intentions and corresponding to the speech text.

### CROSS-REFERENCE TO RELATED APPLICATION(S)

This application claims the benefit of Chinese Patent Application No. 202511612500.5 filed on Nov. 5, 2025, the whole disclosure of which is incorporated herein by reference.

### TECHNICAL FIELD

The present disclosure relates to a field of an artificial intelligence technology, in particular to fields of a speech generation technology, an intelligent customer service technology, a video production technology, etc.

### BACKGROUND

With a rapid development of an artificial intelligence technology, speech data may be generated using a large model. For example, speech script text may be processed based on a speech large model, so as to generate speech data for oral speech of the speech script text.

### SUMMARY

The present disclosure provides a method of generating speech data based on a large model, a method of training a large model, an electronic device, and a storage medium.

According to an aspect of the present disclosure, a method of generating speech data based on a large model is provided, including: receiving prosodic description text and speech text, where the prosodic description text describes pronunciation prosodic intentions for a plurality of text characters in the speech text; performing semantic fusion on the prosodic description text and the speech text by using the large model, so as to obtain a prosodic fusion feature, where a sub-feature in the prosodic fusion feature characterizes a pronunciation prosody of a speech segment with respect to the text characters, and to-be-generated target speech data includes the speech segment; and generating, based on the prosodic fusion feature and a specified pronunciation attribute associated with a specified object, target speech data characterizing that the specified object pronounces in accordance with the pronunciation prosodic intentions and corresponding to the speech text.

According to another aspect of the present disclosure, a method of training a large model is provided, including: receiving sample prosodic description text, sample speech text, and a labeled prosodic fusion feature, where the sample prosodic description text describes pronunciation prosodic intentions for a plurality of sample text characters in the sample speech text, a labeled sub-feature in the labeled prosodic fusion feature characterizes a pronunciation prosody of a labeled speech segment in labeled speech data with respect to the sample text characters, and the labeled speech data characterizes the sample speech text; performing semantic fusion on the sample prosodic description text and the sample speech text by using the large model, so as to obtain a sample prosodic fusion feature; and training the large model based on a difference between the sample prosodic fusion feature and the labeled prosodic fusion feature, so as to obtain a trained large model.

According to another aspect of the present disclosure, an artificial intelligence agent is provided, including: an input module configured to receive input information; a processing module configured to determine a target task based on the input information received by the input module, determine a large model based on the target task, and perform the method provided in embodiments of the present disclosure by invoking the large model, so as to obtain output information; and an output module configured to output the output information obtained by the processing module.

According to another aspect of the present disclosure, an electronic device is provided, including: at least one processor; and a memory communicatively connected to the at least one processor, where the memory stores instructions executable by the at least one processor, and the instructions, when executed by the at least one processor, are configured to cause the at least one processor to implement the method provided in embodiments of the present disclosure.

According to another aspect of the present disclosure, a non-transitory computer-readable storage medium having computer instructions stored therein is provided, where the computer instructions are configured to cause a computer to implement the methods provided in embodiments of the present disclosure.

It should be understood that the content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute a limitation to the present disclosure, in which:

FIG. 1 schematically shows an exemplary system architecture in which a method and an apparatus of generating speech data based on a large model may be applied according to embodiments of the present disclosure;

FIG. 2 schematically shows a flowchart of a method of generating speech data based on a large model according to embodiments of the present disclosure;

FIG. 3 schematically shows a schematic diagram of a method of generating speech data based on a large model according to embodiments of the present disclosure;

FIG. 4 schematically shows a schematic diagram of preceding prosodic prompt information according to embodiments of the present disclosure;

FIG. 5 schematically shows a flowchart of a method of training a large model according to embodiments of the present disclosure;

FIG. 6 schematically shows a schematic diagram of a method of training a large model according to embodiments of the present disclosure;

FIG. 7 schematically shows a schematic diagram of a speech generation model provided in embodiments of the present disclosure;

FIG. 8 schematically shows a block diagram of an apparatus of generating speech data based on a large model according to embodiments of the present disclosure;

FIG. 9 schematically shows a block diagram of an apparatus of generating speech data based on a large model according to embodiments of the present disclosure;

FIG. 10 schematically shows a structural block diagram of an artificial intelligence agent according to embodiments of the present disclosure;

FIG. 11 shows a schematic block diagram of an exemplary electronic device for implementing a method of generating speech data based on a large model and a method of training a large model according to embodiments of the present disclosure.

### DETAILED DESCRIPTION OF EMBODIMENTS

Exemplary embodiments of the present disclosure will be described below with reference to the accompanying drawings, which include various details of embodiments of the present disclosure to facilitate understanding and should be considered as merely exemplary. Therefore, those skilled in the art should realize that various changes and modifications may be made to embodiments described herein without departing from the scope and spirit of the present disclosure. Likewise, for clarity and conciseness, descriptions of well-known functions and structures are omitted in the following description.

In the technical solution of the present disclosure, an acquisition, a storage and an application of user personal information involved comply with provisions of relevant laws and regulations, take necessary confidentiality measures and do not violate public order and good custom.

The inventors have found that, audio content represented by speech data generated based on a speech synthesis technology still has a problem that there is an obviously significant difference between a reading effect of speech and a real reading effect. Especially for speech data generated from a long-paragraph text, there are some problems such as low naturalness, coherence and emotional richness, resulting in inadequate expressiveness of the speech data and difficulty to meet actual needs of a user.

The present disclosure provides a method and an apparatus of generating speech data based on a large model, a method and an apparatus of training a large model, an agent, an electronic device, and a storage medium. The method of generating speech data based on a large model includes: receiving prosodic description text and speech text, where the prosodic description text describes pronunciation prosodic intentions for a plurality of text characters in the speech text; performing semantic fusion on the prosodic description text and the speech text by using the large model, so as to obtain a prosodic fusion feature, where a sub-feature in the prosodic fusion feature characterizes a pronunciation prosody of a speech segment with respect to the text characters, and to-be-generated target speech data includes the speech segment; and generating, based on the prosodic fusion feature and a specified pronunciation attribute associated with a specified object, target speech data characterizing that the specified object pronounces in accordance with the pronunciation prosodic intentions and corresponding to the speech text.

According to embodiments of the present disclosure, by receiving the prosodic description text describing the pronunciation prosodic intentions for the plurality of text characters in the speech text, the large model is instructed to perform the semantic fusion on the prosodic description text and the speech text, such that the output prosodic fusion feature may represent a speech segment in which the text characters in the speech text are pronounced in accordance with the pronunciation prosody corresponding to the pronunciation prosodic intention. Therefore, the prosodic fusion feature may respectively represent the pronunciation prosody of corresponding characters in the speech segment through a plurality of sub-features, so as to improve a degree of accuracy and flexibility of pronunciation prosody control for the speech text. In this way, the target speech data may be generated by fusing a specified pronunciation attribute with the prosodic fusion feature, and each speech segment in the target speech data may be pronounced more accurately in accordance with the pronunciation prosodic intentions, such that the target speech data may naturally and vividly represent that the specified object expresses the speech text in accordance with the pronunciation prosodic intentions indicated by the prosodic description text, so as to improve naturalness, precision, and flexibility of the target speech data for expression of the whole speech text, and improve a speech data quality.

FIG. 1 schematically shows an exemplary system architecture in which a method and an apparatus of generating speech data based on a large model may be applied according to embodiments of the present disclosure.

It should be noted that FIG. 1 shows only an example of a system architecture in which embodiments of the present disclosure may be applied, so as to help those skilled in the art understand the technical content of the present disclosure, but it does not mean that embodiments of the present disclosure may not be applied to other devices, systems, environments or scenarios. For example, in another embodiment, the exemplary system architecture to which the method and the apparatus of generating speech data based on a large model may be applied may include a terminal device. However, the terminal device may implement the method and the apparatus of generating speech data based on a large model provided in embodiments of the present disclosure without interacting with a server.

As shown in FIG. 1, a system architecture 100 according to embodiments may include a first terminal device 101, a second terminal device 102, a third terminal device 103, a network 104 and a server 105. The network 104 is used to provide a medium of a communication link between the first terminal device 101, the second terminal device 102, the third terminal device 103 and the server 105. The network 104 may include various connection types, such as a wired and/or wireless communication link, etc.

The first terminal device 101, the second terminal device 102 and the third terminal device 103 may be used by a user to interact with the server 105 through the network 104, so as to receive or send a message, etc. Various communication client applications may be installed on the first terminal device 101, the second terminal device 102 and the third terminal device 103, such as a knowledge reading application, a web browser application, a search application, an instant messaging tool, an email client and/or a social platform software, etc. (for example only).

The first terminal device 101, the second terminal device 102 and the third terminal device 103 may be various electronic devices having a display screen and supporting web browsing, including but not limited to a smart phone, a tablet computer, a laptop computer, a desktop computer, etc.

The server 105 may be a server providing various services, such as a background management server (for example only) that provides a support for the content browsed by a user using the first terminal device 101, the second terminal device 102 and the third terminal device 103. The background management server may analyze and process received data such as a user request, etc., and feedback a processing result (such as a web page, information, or data, etc. obtained or generated according to the user request) to the terminal device.

It should be noted that the method of generating speech data based on a large model provided in embodiments of the present disclosure may generally be performed by the first terminal device 101, the second terminal device 102 or the third terminal device 103. Accordingly, the apparatus of generating speech data based on a large model provided in embodiments of the present disclosure may generally be provided in the first terminal device 101, the second terminal device 102 or the third terminal device 103.

Alternatively, the method of generating speech data based on a large model provided in embodiments of the present disclosure may generally be performed by the server 105. Accordingly, the apparatus of generating speech data based on a large model provided in embodiments of the present disclosure may generally be provided in the server 105. The method of generating speech data based on a large model provided in embodiments of the present disclosure may also be performed by a server or server cluster that is different from the server 105 and capable of communicating with the first terminal device 101, the second terminal device 102 and the third terminal device 103 and/or the server 105. Accordingly, the apparatus of generating speech data based on a large model provided in embodiments of the present disclosure may also be provided in a server or server cluster that is different from the server 105 and capable of communicating with the first terminal device 101, the second terminal device 102 and the third terminal device 103 and/or the server 105.

It should be understood that the number of terminal devices, networks and servers in FIG. 1 is only schematic. According to implementation needs, any number of terminal devices, networks and servers may be provided

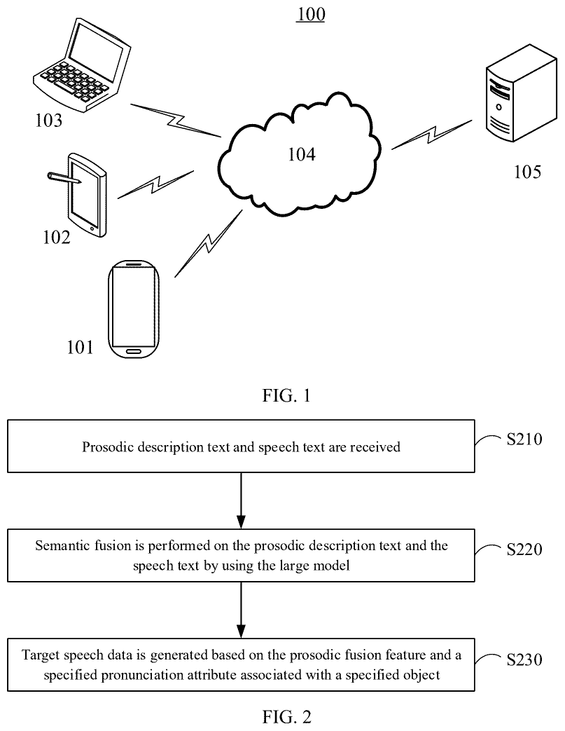

FIG. 2 schematically shows a flowchart of a method of generating speech data based on a large model according to embodiments of the present disclosure.

As shown in FIG. 2, the method of generating speech data based on a large model includes operations S210 to S230.

In the operation S210, prosodic description text and speech text are received.

In the operation S220, semantic fusion is performed on the prosodic description text and the speech text by using the large model.

In the operation S230, target speech data characterizing that the specified object pronounces in accordance with the pronunciation prosodic intentions and corresponding to the speech text is generated based on the prosodic fusion feature and a specified pronunciation attribute associated with a specified object.

According to embodiments of the present disclosure, the speech text represents text content expressed by the to-be-generated target speech data. The speech text may be, for example, speech script text, novel text, screenplay text, advertising and marketing text, etc. The speech text may include a plurality of text characters. In some embodiments, the text character may be a character string represented by syllables formed by spelling consonants and vowels. For example, when the speech text is Chinese text, the text character may be a Chinese character in the speech text. For another example, when the speech text is English or French text, the text character may be an English word or a French word, or the text character may also represent a syllable string composed of consonants and vowels in an English words or a French word.

According to embodiments of the present disclosure, the prosodic description text describes the pronunciation prosodic intentions for the plurality of text characters in the speech text. The pronunciation prosodic intentions include control intentions for the pronunciation prosody of structured text content such as a text character, a word or phrase composed of a plurality of text characters, a text sentence, etc. The pronunciation prosody may represent attributes associated with pronunciation effects, such as pronunciation rhythm, intonation, speech rate, stress, emotion, etc., for the structured text content such as a text character, a word, a phrase, a text sentence, etc. The prosodic description text may describe the pronunciation prosodic intention for the speech text in a textual form of natural language text or structured text. It should be understood that the pronunciation prosodic intention may represent an intention to control pronunciation effects such as pronunciation rhythm between a plurality of characters and a plurality of text characters in the speech text, etc.

For example, the pronunciation prosodic intention may be “fast speech rate and loud voice”. For another example, the pronunciation prosodic intention may be represented by structured text such as “[Speech Rate: Fast], [Intonation: High]”, etc.

In some embodiments, the large model may be constructed based on a Large Language Model (LLM). Based on large-scale model parameters of the large model, full semantic understanding of the pronunciation prosodic intention characterized by the prosodic description text and the speech text may be realized. By performing semantic fusion on the pronunciation prosodic intention and corresponding text content in the speech text, the prosodic fusion feature may characterize audio content in which the speech text is pronounced in accordance with the pronunciation prosodic intention.

In some embodiments, the prosodic fusion feature may include a plurality of sub-features, where each sub-feature in the prosodic fusion feature characterizes a pronunciation prosody of a speech segment with respect to the text characters, and the to-be-generated target speech data includes the speech segment. The prosodic fusion feature may fuse a plurality of text characters in the speech text and a pronunciation prosody corresponding to the plurality of text characters, such that the prosodic fusion feature may fuse audio semantics associated with a pronunciation of the text characters and audio semantics associated with the pronunciation prosody such as rhythm, intonation, emotion, etc. corresponding to the pronunciation prosodic intention. Therefore, the prosodic fusion feature may carry dynamically changing prosodic and pronunciation modes such as text content, text pronunciation, pronunciation prosody expression mode, etc. of the speech text. Based on the large-scale model parameters of the large model, text-modal data may be transformed into the prosodic fusion feature that may represent the pronunciation content of the speech segment, such that the sub-features respectively represent text pronunciation modes and pronunciation prosody of a plurality of speech segments, thereby finely controlling the pronunciation mode of each segment in the speech data using the prosodic description text, so as to improve a degree of accuracy of prosody control of the target speech data.

In some embodiments, the specified pronunciation attribute may represent personalized pronunciation attributes of a specified object, such as timbre, a pronunciation style, etc. of the specified object. By generating the target speech data based on the specified pronunciation attribute and the prosodic fusion feature, the target speech data may present a simulation of the specified object to pronounce the speech text in accordance with the pronunciation prosodic intention indicated by the prosodic description text.

It should be noted that the specified pronunciation attribute may be determined based on object pronunciation data associated with the specified object. For example, the specified pronunciation attribute may be represented based on Mel spectrum data corresponding to the object pronunciation data. For another example, the specified pronunciation attribute may also be obtained by extracting attribute features from the object pronunciation data. The specific determination method and data type of the specified pronunciation attribute will not be limited in embodiments of the present disclosure.

In some embodiments, the target speech data may be obtained by processing the prosodic fusion feature and the specified pronunciation attribute based on a speech large model.

In some embodiments, the generating, based on the prosodic fusion feature and a specified pronunciation attribute associated with a specified object, target speech data characterizing that the specified object pronounces in accordance with the pronunciation prosodic intentions and corresponding to the speech text may include: denosing, based on a diffusion model mechanism, preset noise data according to the prosodic fusion feature and the specified pronunciation attribute, so as to obtain the target speech data.

In some embodiments, the generating, based on the prosodic fusion feature and a specified pronunciation attribute associated with a specified object, target speech data characterizing that the specified object pronounces in accordance with the pronunciation prosodic intentions and corresponding to the speech text may include: fusing the prosodic fusion feature with the specified pronunciation attribute based on an attention mechanism, so as to determine a speech fusion feature; and denoising the preset noise data based on the speech fusion feature, so as to obtain the target speech data.

According to embodiments of the present disclosure, the prosodic fusion feature and the specified pronunciation attribute may be fused based on an attention mechanism by using a trained speech encoder, thereby realizing fine-grained and sufficient fusion of the sub-feature fusing pronunciation modes of the text characters in the speech text and a pronunciation prosody corresponding to the text content with a pronunciation attribute of the specified object, such that the speech fusion feature may accurately represent the speech segment in which the specified object pronounces according to the speech text. Therefore, by denoising the preset noise data based on the speech fusion feature, a plurality of speech segments in the target speech data may accurately represent pronouncing of the text character in accordance with the pronunciation prosodic intention while pronouncing based on the specified pronunciation attribute of the specified object, so as to improve naturalness and fluency of the target speech data in simulating the specified object to express the speech text.

In some embodiments, the speech encoder may be constructed based on a DiT (Diffusion Transformer) network structure. The speech encoder may fully fuse the prosodic fusion feature and the specified pronunciation attribute in time series through a denoising module connected by a plurality of attention layers and residual layers. With the speech fusion feature as a denoising condition for the preset noise data, a global pronunciation attribute of the target speech data characterized by the specified pronunciation attribute and a local text character pronunciation and pronunciation prosody semantics of the speech segment represented by the sub-features in the prosodic fusion feature may be introduced to denoise the preset noise data, so as to reduce a quantization information distortion caused by transforming feature information into speech data, thereby improving the naturalness and fluency of the target speech data.

In some embodiments, the specified pronunciation attribute is determined by performing pronunciation attribute identification on object prompt speech data associated with the specified object.

According to embodiments of the present disclosure, the object prompt speech may be real speech data pronounced by the specified object. For example, the object prompt speech data may be real pronunciation audio such as speech audio, sampled audio, etc. pronounced by the specified object with an authorization of the specified object.

In some embodiments, feature extraction may be performed on the object prompt speech data based on a deep learning model, so as to output the specified pronunciation attribute. For example, the feature extraction may be performed on the object prompt speech data using the trained speech encoder, so as to obtain the specified pronunciation attribute. The trained speech encoder may be constructed based on any type of deep learning algorithms such as a convolutional neural network algorithm, an attention network algorithm, etc.

According to embodiments of the present disclosure, the specified pronunciation attribute may represent personalized and globally stable pronunciation attributes of the specified object, such as timbre, sound quality, pronunciation style, etc. By using the specified pronunciation attribute as a global pronunciation attribute for the specified object to pronounce the speech text, and fusing the specified pronunciation attribute with a plurality of sub-features of the prosodic fusion feature, fine-grained and sufficient fusion of the global pronunciation attribute with the pronunciation and pronunciation prosody of the text character may be realized, such that each speech segment in the target speech data may naturally represent a process of pronunciation of the specified object in accordance with the pronunciation prosodic intention, thereby improving the naturalness and fluency of the target speech data in pronouncing the speech text.

In some embodiments, the prosodic description text characterizes at least one of the following pronunciation prosodic intentions: an accent attribute intention, an emotion attribute intention, a speech rate attribute intention, or an intonation attribute intention.

According to embodiments of the present disclosure, the accent attribute intention may represent that a pronunciation mode of the text character is associated with a specific accent. For example, “British accent” in a description text may represent that the accent attribute intention for a text character “box” is pronunciation [b [symbol] ks], while “American accent” in the description text may represent that the accent attribute intention is pronunciation [b [symbol] ks]. The large model may fully fuse pronunciation semantics and pronunciation prosody of characters in the speech text by understanding text semantics characterizing the accent attribute intention such as “American accent” or the like in the prosodic description text, so as to realize the pronunciation in accordance with the accent attribute intention based on the sub-features.

According to embodiments of the present disclosure, the text content characterizing the emotion attribute intention in the prosodic description text may represent an emotional pronunciation effect for text characters in the speech text. The pronunciation prosody corresponding to the emotion attribute intention may characterize emotional attributes such as speech rate, intonation, rhythm, etc. For example, the text content characterizing the emotion attribute intention in the prosodic description text may be “joyful”, and the sub-feature in the prosodic fusion feature may characterize pronunciation prosody with a cheerful pronunciation rhythm and a high pitch for the text character.

The large model may perform semantic understanding on the text content characterizing the emotion attribute intention in the prosodic description text, and fuse a pronunciation prosody corresponding to the emotion attribute intention into the text characters of the speech text based on semantic content of the speech text, such that the plurality of sub-features in the prosodic fusion feature may fine-grainedly characterize speech segments that express the text characters in the speech text in accordance with the pronunciation prosodic intention. Therefore, a plurality of speech segments in a plurality of target speech data may accurately express each text character in a long-form speech text in accordance with the emotion attribute intention. In this way, the speech segments may fully fuse the pronunciation of the text characters with the pronunciation prosody corresponding to an emotion attribute, so as to improve naturalness and emotional coherence of the target speech data by matching the pronunciation content and pronunciation prosody of the text characters expressed by the plurality of speech segments with the emotion attribute intention.

According to embodiments of the present disclosure, the text content characterizing the speech rate attribute intention in the prosodic description text may represent an intention to control a pronunciation speed of the speech text. For example, the text content characterizing the speech rate attribute intention in the prosodic description text may be “fast speech rate”, “steady speech rate”, or other text content representing a speech rate.

The large model may perform semantic understanding on the text content characterizing the speech rate attribute intention in the prosodic description text, and fuse a pronunciation prosody corresponding to the speech rate attribute intention into the text characters of the speech text based on the semantic content of the speech text, such that the plurality of sub-features in the prosodic fusion feature may fine-grainedly characterize speech segments that express the text characters in the speech text at a speech rate corresponding to the pronunciation prosodic intention. Therefore, the plurality of speech segments in the plurality of target speech data may accurately express each text character in the long-form speech text in accordance with the speech rate attribute intention. In this way, the speech segments may fully fuse the pronunciation of the text characters with the pronunciation prosody corresponding to a speech rate attribute, so as to improve the naturalness and emotional coherence of the target speech data by matching the pronunciation content and pronunciation prosody of the text characters expressed by the plurality of speech segments with the speech rate attribute intention.

According to embodiments of the present disclosure, the text content characterizing the intonation attribute intention in the prosodic description text may represent an intention to control an emotional intonation effect of intonation pronunciation of the text characters in the speech text. For example, the text content characterizing the intonation attribute intention in the prosodic description text may be “high-pitched”, “whispered”, or other text content representing intonation.

The large model may perform semantic understanding on the text content characterizing the intonation attribute intention in the prosodic description text, and fuse a pronunciation prosody corresponding to the intonation attribute intention into the text characters of the speech text based on the semantic content of the speech text, such that the plurality of sub-features in the prosodic fusion feature may fine-grainedly characterize speech segments that express the text characters in the speech text with an intonation corresponding to the pronunciation prosodic intention. Therefore, the plurality of speech segments in the plurality of target speech data may accurately express each text character in the long-form speech text in accordance with the intonation attribute intention such as high-pitched, whispered, etc. In this way, the speech segments may fully fuse the pronunciation of the text characters with the pronunciation prosody corresponding to an intonation attribute, so as to improve the naturalness and emotional coherence of the target speech data by matching the pronunciation content and pronunciation prosody of the text characters expressed by the plurality of speech segments with the intonation attribute intention.

In some embodiments, the pronunciation prosodic intention characterized in the prosodic description text may include any combination of the accent attribute intention, the emotion attribute intention, the speech rate attribute intention, and the intonation attribute intention, which will not be repeated in embodiments of the present disclosure.

In some embodiments, the performing semantic fusion on the prosodic description text and the speech text by using the large model may include: performing, based on the prosodic description text as prompt information, semantic fusion on the pronunciation prosodic intentions associated with the text characters and at least one text character by using the large model, so as to obtain a plurality of sequentially arranged sub-features.

According to embodiments of the present disclosure, the prosodic description text may be any type of data such as text or speech input by a producer of the target speech data according to actual needs. The plurality of sequentially arranged sub-features correspond to the plurality of speech segments in the target speech data.

For example, the pronunciation prosodic intention characterized by the prosodic description text may include any combination of the accent attribute intention, the emotion attribute intention, the speech rate attribute intention, and the intonation attribute intention. The large model may learn the pronunciation prosodic intention characterized by the prosodic description text by performing semantic understanding on the prosodic description text based on the prosodic description text as the prompt information. According to the function of the prompt information, large-scale model parameters of the large model may be controlled to perform audio-semantic fusion on the text characters in the speech text according to the pronunciation prosody such as accent, emotion, speech rate, etc. characterized by the pronunciation prosodic intention, such that the sub-features in the prosodic fusion feature may fine-grainedly characterize pronunciation modes of the text characters in the speech segment. Therefore, the plurality of sequentially arranged sub-features may respectively represent audio feature attributes of the plurality of speech segments.

According to embodiments of the present disclosure, by fusing a plurality of discretized and sequentially arranged sub-features in the prosodic fusion feature with the specified pronunciation attribute, the pronunciation prosody and pronunciations characterized by each sub-feature characterizing each speech segment may be adjusted according to a pronunciation mode of the specified object, such that the target speech data may accurately simulate an oral broadcasting process of the specified object for the speech text in accordance with the pronunciation prosodic intention, so as to improve authenticity and fluency of the target speech data.

According to embodiments of the present disclosure, the performing, based on the prosodic description text as prompt information, semantic fusion on the pronunciation prosodic intentions associated with the text characters and at least one text character by using the large model includes: by using the large model, determining, from the speech text, specified text characters respectively matching the pronunciation prosodic intentions characterized by the prosodic description text by performing semantic understanding on the prosodic description text; and performing semantic fusion on the pronunciation prosodic intentions respectively corresponding to the specified text characters and the specified text characters in the speech text, so as to output the sub-features associated with the specified text characters.

In some embodiments, the prosodic description text may represent pronunciation prosodic intention text and mapping text by means of natural language description or structured text. The pronunciation prosodic intention text is associated with the pronunciation prosodic intention, and the mapping text is used to indicate a specified text character matching the pronunciation prosodic intention.

For example, the prosodic description text is: “the first half has an average speech rate and a steady pitch, while the second half has a slightly faster speech rate and a high pitch”, where “the first half” may be the mapping text, and “an average speech rate and a steady pitch” is the pronunciation prosodic intention text semantically associated with the mapping text. By performing semantic understanding on the prosodic description text, the large model may fuse a pronunciation prosody of an average speech rate and a steady pitch into each of the first 5 text sentences among the 10 text sentences in the speech text, and fuse a pronunciation prosody of an accelerated speech rate and a high pitch into the last 5 text sentences. Therefore, the plurality of sequentially arranged sub-features characterize the pronunciation prosody corresponding to each text sentence, such as a speech rate, a pitch, etc., so as to improve a fine-grained prosodic control capability for the plurality of speech segments in the target speech data, and improve the coherence and naturalness of the target speech data.

For another example, the prosodic description text is: “a product name ‘AA brand hiking boots’ in the speech text is expressed using a high pitch.” Therefore, by performing semantic understanding on the prosodic description text, the large model may enable the generated sub-features to represent the pronunciation of “AA brand hiking boots” with a specific pronunciation prosody of a high pitch, such that a speech segment associated with “AA brand hiking boots” in the target speech data may be accurately expressed in accordance with the pronunciation prosodic intention, so as to improve an audio promotional effect and naturalness of the target speech data.

According to embodiments of the present disclosure, in order to further enhance expressiveness and controllability of the target speech data generated by performing speech data generation on the speech text, the large model is used to process the prosodic description text as a text instruction, so as to realize a fine-grained adjustment capability of the large model to generate speech data that meets diverse prosodic variation requirements. By allowing a user to insert structured control tags, such as emotion, speech rate, pause duration, etc. as the prosodic description text or prosodic description text based on natural language description before or during the generation of the target speech data, the inserted prosodic description text may be used as an important input signal for the large model, which may endow the target speech data with quantifiable and predictable control capability over expression details, and enable it to accurately change pronunciation prosody modes of the target speech data, such as tone, rhythm, etc., according to instruction requirements, thereby greatly enriching expressiveness and layering of the target speech data.

In some embodiments, the speech text includes a target text sentence and a preceding text sentence arranged before the target text sentence. For example, a speech segment corresponding to the target text sentence may not have been generated yet, while a speech segment corresponding to the preceding text sentence has already been generated.

According to embodiments of the present disclosure, the performing semantic fusion on the prosodic description text and the speech text by using the large model may further include: performing, based on preceding prosodic prompt information corresponding to the target text sentence, semantic fusion on the prosodic description text and the target text sentence by using the large model, so as to obtain a target sub-feature corresponding to the target text sentence.

According to embodiments of the present disclosure, the preceding prosodic prompt information is determined based on a sub-feature corresponding to the preceding text sentence in the prosodic fusion feature.

For example, a plurality of first sub-features corresponding to a plurality of preceding text sentences may be used as the preceding prosodic prompt information, and a plurality of preceding sub-features, the target text sentence and the prosodic description text may be processed using the large model, so as to obtain a plurality of target sub-features corresponding to the target text sentence. Therefore, the plurality of target sub-features may be naturally connected to a pronunciation prosody characterized by the preceding sub-features, thereby realizing a natural and smooth pronunciation prosody transition for speech segments characterized by the plurality of sub-features in the prosodic fusion feature, so as to improve naturalness and pronunciation prosody fluency of the target speech data.

It should be understood that, for a subsequent text sentence arranged after the target text sentence, by using the plurality of first sub-features and the target sub-features as preceding prosodic prompt information of the subsequent text sentence, the large model may process the plurality of first sub-features, the target sub-features, the prosodic description text and the subsequent text sentence, so as to obtain a plurality of second sub-features corresponding to the subsequent text sentence. Therefore, by fusing the already generated sub-features using the large model by a stream processing method, fusion and natural transition of the pronunciation prosody may be performed for the plurality of subsequent text sentences in the speech text, so as to improve consistency and transition naturalness of the pronunciation prosody of the plurality of speech segments in the target speech data and improve an overall effect of the target speech data.

In some embodiments, the performing, based on the prosodic description text as prompt information, semantic fusion on the pronunciation prosodic intentions associated with the text characters and at least one text character by using the large model may further include: determining, from the speech text, specified text characters respectively matching the pronunciation prosodic intentions characterized by the prosodic description text by performing semantic understanding on the prosodic description text using the large model; and performing semantic fusion on the pronunciation prosodic intentions respectively corresponding to the specified text characters and the specified text characters in the speech text based on the preceding prosodic prompt information by using the large model, so as to output the sub-features associated with the specified text characters. Therefore, while realizing accurate fusion of the pronunciation prosodic intention corresponding to the text characters may be realized according to the prosodic description text, natural transition of the sub-features to the pronunciation prosody characterized by the preceding prosodic prompt information may be realized, thereby improving degree of naturalness of connection and fluency between the plurality of speech segments in the target speech data.

In some embodiments, the preceding prosodic prompt information may further include the preceding text sentence and sub-features corresponding to the preceding text sentence. In this way, the large model may combine a semantic structural relationship between the preceding text sentence and the target text sentence to further more accurately fuse the pronunciation prosody associated with the target text characters in the target text sentence in accordance with the prosodic description text. Moreover, the pronunciation prosody of the target text characters characterized by the plurality of target sub-features may be naturally connected to a pronunciation prosody associated with the preceding text sentence under a condition of fully understanding text semantics of the preceding text sentence, and the pronunciation prosody represented by the plurality of speech segments in the target speech data may realize natural and fluent expression of the speech text by combining the pronunciation prosodic intention and a development method for the text semantics of the speech text, such that the target speech data may more realistically simulate a pronunciation effect of a real object expressing the speech text in accordance with the prosodic description text, thereby improving a data quality of the target speech data.

In some embodiments, the preceding prosodic prompt information includes object prompt speech data characterizing pronunciation content of the specified object, the preceding text sentence, and the sub-feature corresponding to the preceding text sentence.

According to embodiments of the present disclosure, the object prompt speech data may be, for example, speech audio data, conversation audio data, etc., actually expressed by the specified object. The object prompt speech data may be obtained and used only with an authorization of the specified object or a relevant authorized authority.

According to embodiments of the present disclosure, with a powerful learning capability of long-context text semantics and pronunciation semantics of the large model, by using the pronunciation prosody of the preceding text sentence in the speech text, text characters of a current target text sentence, and the prosodic description text as a prosodic understanding basis for global perception of the target sub-features, the large model may not only focus on the current target text sentence, but also perform overall planning for the speech segment of the target text sentence based on the theme and logical structure of the whole speech text, thereby realizing the target sub-features that may be naturally connected to the pronunciation prosody of the preceding text sentence.

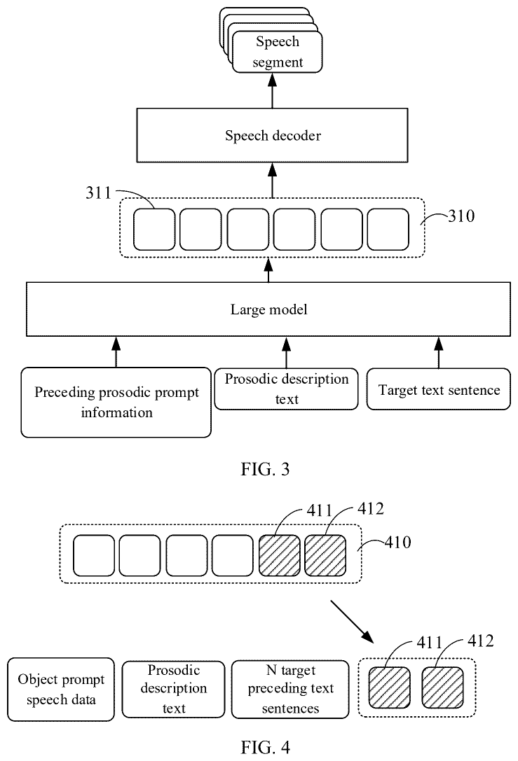

FIG. 3 schematically shows a schematic diagram of a method of generating speech data based on a large model according to embodiments of the present disclosure.

As shown in FIG. 3, the large model may be constructed based on a Mixture of Experts (MoE) model architecture. For the target text sentence in the speech text, the preceding text sentence arranged before the target text sentence may be determined from the speech text, and a plurality of sub-features corresponding to the preceding text sentence may be determined. The preceding text sentence, the sub-features corresponding to the preceding text sentence, and object prompt speech data representing real speech of the specified object are used as the preceding prosodic prompt information.

By processing the preceding prosodic prompt information, the prosodic description text, and the target text sentence using the large model, the large model may perform semantic fusion on pronunciations corresponding to the text characters in the target text sentence and the pronunciation prosodic intention represented by the prosodic description text based on the preceding prosodic prompt information. In this way, a plurality of output target sub-features 310 may fuse pronunciations of the text characters in the target text sentence with the pronunciation prosodic intention, and a smooth transition between the pronunciation prosody of the speech segments characterized by the plurality of target sub-features and the pronunciation prosody of the speech segments corresponding to the preceding text sentence may be realized. For example, a transition between the speech segment corresponding to a first target sub-feature 311 and the speech segment corresponding to the preceding text sentence may be realized through a unified rhythm, speech rate, and pitch.

By sequentially inputting the plurality of target sub-features 310 and a plurality of sub-features respectively corresponding to other text sentences in the speech text in an order of text sentences into a trained speech decoder, target speech data including a plurality of speech segments may be output.

Because the large model is constructed based on the MoE model architecture, in a process of performing a computational task for outputting a plurality of sub-features, the large model may activate part of model parameters in the large model through a gating mechanism to perform the computational task, so as to reduce computational resources required for generating the target speech data, improve computational efficiency, and improve an output latency of the target speech data in scenarios such as intelligent Q&A, audio production, etc. At the same time, in order to mitigate a degradation of audio generation quality of the target speech data caused by a plurality of discretized sub-features, a representation of the fused pronunciation prosody and character pronunciations in a hidden space from a plurality of sequentially arranged consecutive sub-features may be learned through a speech decoder of a flow-matching mode, and the representation in the hidden space may be smoothly mapped to an audio spectrum space of the target speech data, which may ensure generation efficiency while improving audio fidelity and naturalness of the target speech data.

In some embodiments, M preceding text sentences are provided, and the preceding prosodic prompt information is determined based on N target preceding text sentences adjacent to the target text sentence among the M preceding text sentences, where M>N≥1, and M and N are integers.

According to embodiments of the present disclosure, the N target preceding text sentences adjacent to the target text sentence are adjacent to the target text sentence in position. The preceding prosodic prompt information may include the object prompt speech data, the N target preceding text sentences, and a plurality of sub-features corresponding to the N target preceding text sentences.

FIG. 4 schematically shows a schematic diagram of preceding prosodic prompt information according to embodiments of the present disclosure.

As shown in FIG. 4, among a plurality of sub-features 410 corresponding to the M preceding text sentences, a first target preceding sub-feature 411 and a second target preceding sub-feature 412 are the plurality of sub-features corresponding to the N target preceding text sentences among the M preceding text sentences, where M>N≥1, and M and N are integers. The first target preceding sub-feature 411, the second target preceding sub-feature 412, the N target preceding text sentences, the prosodic description text used for generating the plurality of sub-features 410, and the object prompt speech data of the specified object are used as the preceding prosodic prompt information for the target text sentence. By inputting the preceding prosodic prompt information, the target text sentence, and the prosodic description text into the large model, the large model may output a plurality of target sub-features corresponding to the target text sentence. By processing the plurality of target sub-features and the specified pronunciation attribute using a speech decoder, a plurality of speech segments corresponding to the target text sentence may be obtained.

Therefore, when a plurality of prosodic description texts are repeatedly input to the large model, a long-form speech text may be divided into batches with each batch including M text sentences. Sub-features corresponding to M text sentences may be output in one batch by a pipeline mode of “predicting while generating” of the large model, and the speech segment may be generated in real time by using the speech decoder of the flow-matching mode, which may effectively reduce waiting time for generating the target speech data from the speech text, thereby meeting requirements of scenarios such as online broadcasting, interactive applications, etc. with strict requirements on low latency. In addition, by fusing the pronunciation prosodic intention and the pronunciation mode of the text characters in the text sentence using the large model according to the prosodic description text, a simulation accuracy of simulating the pronunciation attribute of the specified object for the target speech data may be improved, which may vividly transfer a speech expression style of the specified object to the target speech data for the speech text, thereby improving a rich transfer effect and realizing an ability of generating the target speech data for an infinitely long speech text with streaming input.

Finally, by introducing the preceding prosodic prompt information as a historical audio caching strategy, when generating speech segments corresponding to a plurality of target text sentences in a current batch, the sub-features of the N preceding text sentences adjacent to the target text sentence and the preceding text sentences are used as prompts for the large model. In this way, the large model may fully understand the pronunciation prosody and the text content of the preceding text sentence that requires a natural transition with the target text sentence in the speech text, and the pronunciation prosody of the speech segment characterized by the target sub-feature may be naturally connected to the pronunciation prosody of the speech segment of the preceding text sentence. Furthermore, a new speech segment may be generated by iteratively using text sentences processed by the large model in the current batch as target text sentences, so as to effectively generate a target speech data for an infinitely long-paragraph text, and greatly expand application scenarios of the method of generating speech data.

According to the method of generating speech data based on a large model provided in embodiments of the present disclosure, embodiments of the present disclosure further provide a method of training a large model. The trained large model determined by the method of training a large model provided in embodiments of the present disclosure may be applied to the method of generating speech data based on a large model provided in embodiments of the present disclosure.

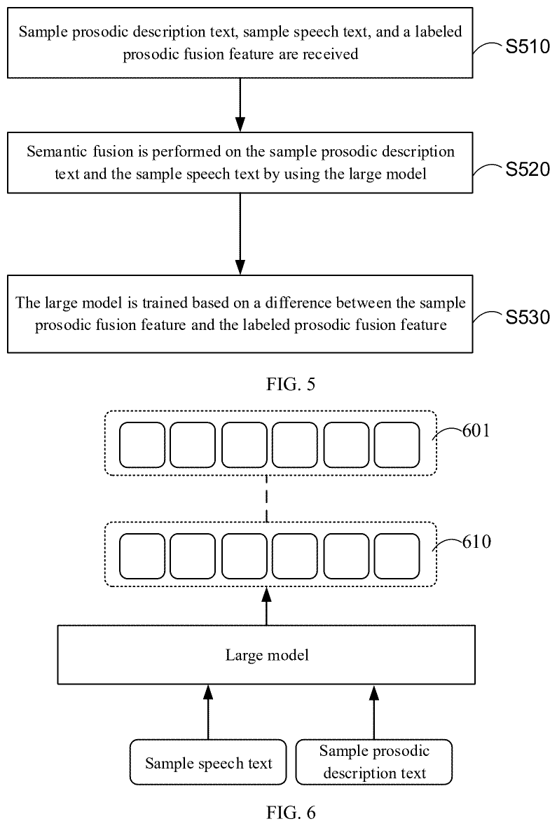

FIG. 5 schematically shows a flowchart of a method of training a large model according to embodiments of the present disclosure.

As shown in FIG. 5, the method of training a large model includes operations S510 to S530.

In the operation S510, sample prosodic description text, sample speech text, and a labeled prosodic fusion feature are received.

In the operation S520, semantic fusion is performed on the sample prosodic description text and the sample speech text by using the large model, so as to obtain a sample prosodic fusion feature.

In the operation S530, the large model is trained based on a difference between the sample prosodic fusion feature and the labeled prosodic fusion feature, so as to obtain a trained large model.

According to embodiments of the present disclosure, the sample prosodic description text describes pronunciation prosodic intentions for a plurality of sample text characters in the sample speech text, a labeled sub-feature in the labeled prosodic fusion feature characterizes a pronunciation prosody of a labeled speech segment in labeled speech data with respect to the sample text characters.

According to embodiments of the present disclosure, the labeled speech data characterizes the sample speech text. For example, the labeled speech data may be real speech data for oral expression of the sample speech text by a sample specified object. The labeled prosodic fusion feature may be determined by performing prosodic feature extraction on the labeled speech data. For example, the prosodic feature extraction may be performed on the labeled speech data using a trained speech encoder, such that the labeled prosodic fusion feature may fuse the pronunciation prosodic intention characterized by the sample prosodic description text with pronunciations of the plurality of sample text characters in the sample speech text.

According to embodiments of the present disclosure, a sample sub-feature in the sample prosodic fusion feature characterizes a pronunciation prosody of labeled text characters in the speech segment. Therefore, supervised training of the large model may be performed based on a difference between the sample sub-feature and the labeled sub-feature, so as to obtain the trained large model.

According to embodiments of the present disclosure, the training the large model based on a difference between the sample prosodic fusion features and the labeled prosodic fusion feature may include: processing the sample prosodic fusion feature and the labeled prosodic fusion feature using a loss function, so as to obtain a loss value, and adjusting model parameters of the large model based on a loss value until the loss function converges, so as to obtain the trained large model.

In some embodiments, the performing semantic fusion on the sample prosodic description text and the sample speech text by using the large model may include: processing the sample prosodic description text, a sample target text sentence in the sample speech text, a sample preceding text sentence adjacent to the sample target text sentence, and a sample sub-feature corresponding to the sample preceding text sentence by using the large model. In this way, the large model may generate a sample target sub-feature that enables a natural transition of the pronunciation prosody based on the pronunciation prosody of the preceding text sentence corresponding to the sample target text sentence.

It should be noted that the technical terms involved in the method of training a large model provided in embodiments of the present disclosure, including but not limited to the sample prosodic fusion feature, the sample speech text, the sample prosodic description text, the large model, etc., and the technical terms involved in the method of generating speech data based on a large model provided in embodiments of the present disclosure, including but not limited to the prosodic fusion feature, the speech text, the prosodic description text, the large model, etc., have the same or similar attributes and belong to the same type of technical features, which will not be repeated in embodiments of the present disclosure.

The models such as the large model, the speech encoder, the speech decoder, etc. involved in the method of training a large model provided in embodiments of the present disclosure and the models such as the large model, the speech encoder, the speech decoder, etc. involved in the method of generating speech data based on a large model provided in embodiments of the present disclosure have the same or similar model structures, which will not be repeated in embodiments of the present disclosure.

FIG. 6 schematically shows a schematic diagram of a method of training a large model according to embodiments of the present disclosure.

As shown in FIG. 6, the sample speech text and the sample prosodic description text are input to the large model to output a sample prosodic fusion feature 610, and the sample prosodic fusion feature 610 and a labeled prosodic fusion feature 601 are processed using a loss function, so as to obtain a loss value. Model parameters of the large model are adjusted using the loss value until the loss value converges, so as to obtain a trained large model.

In some embodiments, the labeled prosodic fusion feature is determined by processing the labeled speech data through a trained speech encoder, and the trained speech encoder is determined by: performing feature extraction on reference speech data by using a speech encoder, so as to obtain a pre-trained prosodic fusion feature and a pre-trained pronunciation attribute; generating pre-trained speech data based on the pre-trained prosodic fusion feature and the pre-trained pronunciation attribute; and training the speech encoder based on a difference between the pre-trained speech data and the reference speech data, so as to obtain the trained speech encoder.

According to embodiments of the present disclosure, the pre-trained pronunciation attribute is associated with a sample object orally expressing the labeled speech data. For example, the pre-trained pronunciation attribute may represent stable attributes related to a pronunciation mode of the sample object, such as timbre, sound quality, pronunciation style, etc. For example, the specified pronunciation attribute involved in embodiments of the present disclosure may have the same attribute as the pre-trained pronunciation attribute.

According to embodiments of the present disclosure, a pre-trained sub-feature in the pre-trained prosodic fusion feature characterizes a pronunciation prosody of a reference speech segment in the reference speech data with respect to reference text characters in a reference speech text. The semantics characterized by the pre-trained prosodic fusion feature may be similar to the semantics characterized by the sample prosodic fusion feature or the labeled prosodic fusion feature, which will not be repeated in embodiments of the present disclosure.

In some embodiments, the speech encoder may be constructed based on an attention network algorithm, or may also be constructed based on other types of neural network algorithms. The specific type of algorithm for constructing the speech encoder will not be limited in embodiments of the present disclosure.

According to embodiments of the present disclosure, the generating pre-trained speech data based on the pre-trained prosodic fusion feature and the pre-trained pronunciation attribute may include: processing the pre-trained prosodic fusion feature and the pre-trained pronunciation attribute by using a speech decoder, so as to generate the pre-trained speech data.

According to embodiments of the present disclosure, the training the speech encoder based on the difference between the pre-trained speech data and the reference speech data may include: processing the pre-trained speech data and the reference speech data based on a loss function, so as to obtain a pre-training loss value, and adjusting model parameters of the speech encoder based on the pre-training loss value until the pre-training loss value converges, so as to obtain the trained speech encoder. Therefore, the reference speech data may be restored using the speech encoder and the speech decoder, so as to obtain the pre-trained speech data, such that the trained speech encoder may accurately learn a prosodic expression style of the reference speech data for the text characters of the reference speech text.

According to embodiments of the present disclosure, by performing feature extraction on the labeled speech data through the trained speech encoder, the labeled prosodic fusion feature output by the trained speech encoder may accurately characterize a prosodic expression style of the speech segment with respect to the text characters of the sample speech text. Therefore, based on the labeled prosodic fusion feature output by the trained speech encoder as a labeled truth value, a comprehension ability and a semantic fusion ability of the large model for the pronunciation prosodic intention characterized by the sample prosodic description text may be trained. In this way, the trained large model may accurately understand the pronunciation prosodic intention and the pronunciations of the text characters in the speech text, such that the prosodic fusion feature output by the large model may accurately map the speech text to an audio expression space according to the pronunciation prosodic intention characterized by the prosodic description text, so as to improve an expression accuracy of the target speech data for the pronunciation prosody, improve a prosodic expression effect of the target speech data, and improve speech naturalness, fluency, and pronunciation layering.

In some embodiments, the pre-trained speech data is generated by denoising sample preset noise data through a speech decoder of a speech generation model based on the pre-trained prosodic fusion feature and the pre-trained pronunciation attribute, and the speech generation model further includes the speech encoder.

In some embodiments, the training the speech encoder based on a difference between the pre-trained speech data and the reference speech data includes: training the speech encoder and the speech decoder based on the difference between the pre-trained speech data and the reference speech data.

For example, the model parameters of the speech encoder and the speech decoder may be adjusted based on the pre-training loss value until the pre-training loss value converges, so as to obtain the trained speech encoder and the trained speech decoder. The trained speech encoder may be used to process the labeled speech data to generate the labeled prosodic fusion feature. The trained speech decoder may be used in the method of generating speech data based on a large model provided in embodiments of the present disclosure. For example, the specified pronunciation attribute and the prosodic fusion feature may be processed using the trained speech decoder, so as to denoise the preset noise data, and the target speech data characterizing that the specified object pronounces the speech text in accordance with the pronunciation prosodic intention.

In some embodiments, the performing feature extraction on reference speech data by using a speech encoder may include: performing the feature fusion on the reference speech data based on an attention mechanism, so as to obtain an initial sample fusion feature; and performing a convolutional downsampling operation on the initial sample fusion feature to obtain the pre-trained prosodic fusion feature.

In an example, feature fusion may be performed on the reference speech data using a Transformer algorithm, so as to obtain an initial sample fusion feature that fully fuses an audio feature of the reference speech data. By performing the convolutional downsampling operation on the initial sample fusion feature, a dimension of the labeled prosodic fusion feature output by the speech encoder may be reduced. In this way, the large model may be trained by outputting the sample prosodic fusion feature with the same dimension as the labeled prosodic fusion feature, such that the trained large model may output the prosodic fusion feature with a small data volume, thereby reducing a computational resource consumption for generating target speech data based on the prosodic fusion feature and the specified pronunciation attribute, and improving an output efficiency of the target speech data.

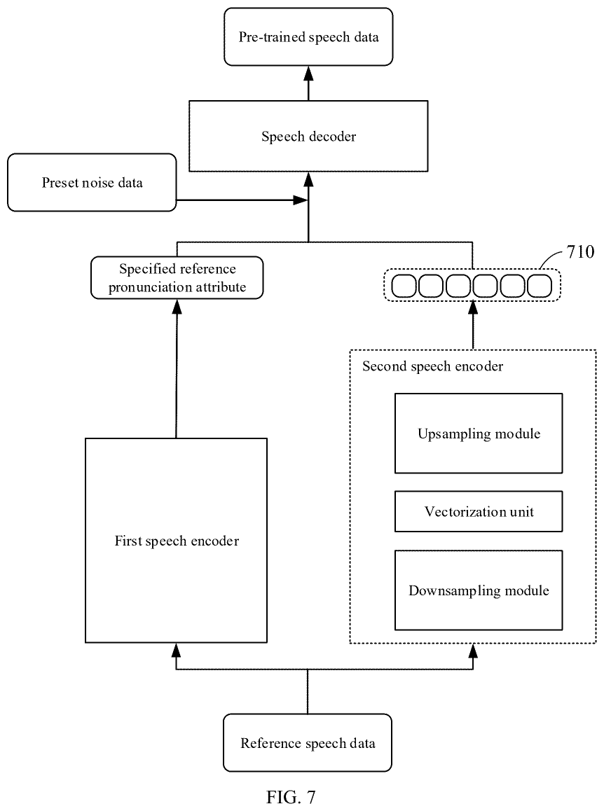

FIG. 7 schematically shows a schematic diagram of a speech generation model according to embodiments of the present disclosure.

As shown in FIG. 7, the speech generation model may include a first speech encoder, a second speech encoder, and a speech decoder. The first speech encoder is composed of a plurality of stacked Transformer layers and an average pooling layer. The second speech encoder is constructed based on a symmetric network structure, and the second speech encoder includes a downsampling module, a vectorization unit, and an upsampling module. The downsampling module includes an attention unit, a convolutional downsampling unit, and a vectorization unit. The attention unit includes a plurality of attention network layers, and the convolutional downsampling unit includes two convolutional downsampling layers with a stride of 2. The vectorization unit includes a Vector Quantization (VQ) layer. The upsampling module includes two convolutional upsampling layers with a stride of 2 and a plurality of attention network layers.

The first speech encoder processes reference speech data and outputs a pre-trained pronunciation attribute. The second speech encoder processes the reference speech data and outputs a pre-trained prosodic fusion feature 710. Based on the symmetric network structure, the second speech encoder may effectively compress and restore the audio feature of the reference audio data. Therefore, the pre-trained speech data and the reference speech data may be processed using a loss function, so as to obtain a pre-training loss value. The first speech encoder, the second speech encoder, and the speech decoder are trained based on the pre-training loss value until the pre-training loss value converges, so as to obtain a trained second speech encoder and the trained speech decoder. The labeled prosodic fusion feature is generated using the trained second speech encoder, so as to train the large model. The trained speech decoder and the trained large model are used to perform the method of generating speech data based on a large model provided in embodiments of the present disclosure.

In an embodiment, the second speech encoder may include a downsampling module and a vectorization unit, but does not include an upsampling module. Therefore, the feature fusion may be performed on the reference speech data based on an attention mechanism by an attention network layer in the downsampling module, so as to obtain an initial sample fusion feature. The convolutional downsampling operation is performed on the initial sample fusion feature by the convolutional downsampling layer in the downsampling module, so as to obtain the pre-trained prosodic fusion feature. The preset noise data is denoised using the speech decoder based on a specified reference pronunciation attribute and a low-dimensional pre-trained prosodic fusion feature, so as to output the pre-trained speech data. The pre-trained speech data and the reference speech data may be processed using a loss function, so as to obtain the pre-training loss value. The first speech encoder, the second speech encoder, and the speech decoder may be trained based on the pre-training loss value until the pre-training loss value converges, so as to obtain the trained second speech encoder and the trained speech decoder. The labeled prosodic fusion feature is generated using the trained second speech encoder, so as to train the large model.

For example, the trained speech decoder and the trained large model are used to perform the method of generating speech data based on a large model provided in embodiments of the present disclosure. Through two convolutional layers with a stride of 2, a frame rate of the audio feature of original reference speech data is reduced to ¼ of the original frame rate, which may greatly reduce a data volume of a subsequent discretized labeled prosodic fusion feature. This may reduce a modeling difficulty of the large model, while improving a generation efficiency of the trained large model to generate the target speech data during a reasoning process. In addition, the vectorization unit uses only a vector quantization layer, thereby avoiding an excessive computational resource consumption caused by using multi-level residual vector quantization layers to output a discretized labeled prosodic fusion feature. Therefore, an execution efficiency of the large model in performing the method of generating speech data based on a large model may be improved by using a discretized feature output by the vectorization unit as the labeled prosodic fusion feature, thereby reducing generation latency of the target speech data.

According to embodiments of the present disclosure, by training the speech encoder and the speech decoder in the speech generation model based on the reference speech data, the trained speech encoder may acquire speech data restoration capability. Furthermore, based on the speech data restoration capability of the speech encoder, accurate extraction of the prosodic fusion feature associated with the pronunciation prosody and character pronunciations from the labeled speech data may be realized, such that the labeled sub-feature in the labeled prosodic fusion feature may accurately characterize the pronunciation prosody of the labeled speech segment in the labeled speech data with respect to the sample text characters. Therefore, the large model may be trained based on the trained speech encoder, such that the trained large model may accurately extract the prosodic fusion feature characterizing a pronunciation prosody of a speech modality based on prosodic description text and speech text of a text modality, so as to realize precise matching of the pronunciation prosodic intention, thereby improving fluency, naturalness and layering of the target speech data and improving a quality of the target speech data.

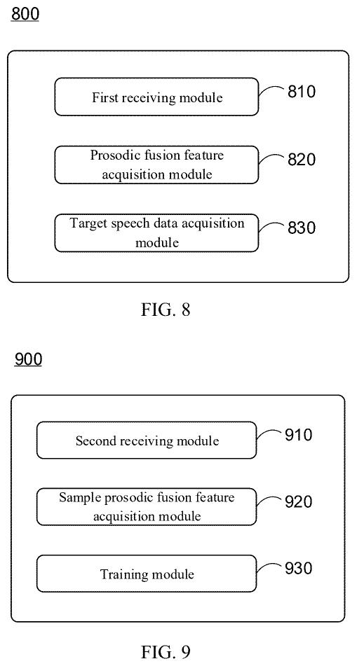

FIG. 8 schematically shows a block diagram of an apparatus of generating speech data based on a large model according to embodiments of the present disclosure.

As shown in FIG. 8, an apparatus 800 of generating speech data based on a large model includes: a first receiving module 810, a prosodic fusion feature acquisition module 820, and a target speech data acquisition module 830.

The first receiving module 810 is used to receive prosodic description text and speech text, where the prosodic description text describes pronunciation prosodic intentions for a plurality of text characters in the speech text.

The prosodic fusion feature acquisition module 820 is used to perform semantic fusion on the prosodic description text and the speech text by using the large model, so as to obtain a prosodic fusion feature, where a sub-feature in the prosodic fusion feature characterizes a pronunciation prosody of a speech segment with respect to the text characters, and to-be-generated target speech data includes the speech segment.

The target speech data acquisition module 830 is used to generate, based on the prosodic fusion feature and a specified pronunciation attribute associated with a specified object, target speech data representing that the specified object pronounces in accordance with the pronunciation prosodic intentions and corresponding to the speech text.

According to embodiments of the present disclosure, the prosodic fusion feature acquisition module includes a fusion unit.

The fusion unit is used to perform, based on the prosodic description text as prompt information, semantic fusion on the pronunciation prosodic intentions associated with the text characters and at least one text character by using the large model, so as to obtain a plurality of sequentially arranged sub-features.

According to embodiments of the present disclosure, the fusion unit is configured to: by using the large model, determine, from the speech text, specified text characters respectively matching the pronunciation prosodic intentions characterized by the prosodic description text by performing semantic understanding on the prosodic description text; and perform semantic fusion on the pronunciation prosodic intentions respectively corresponding to the specified text characters and the specified text characters in the speech text, so as to output the sub-features associated with the specified text characters.

According to embodiments of the present disclosure, the speech text includes a target text sentence and a preceding text sentence arranged before the target text sentence, and the prosodic fusion feature acquisition module includes a target sub-feature acquisition unit.

The target sub-feature acquisition unit is configured to: by using the large model, perform, based on preceding prosodic prompt information corresponding to the target text sentence, semantic fusion on the prosodic description text and the target text sentence by using the large model, so as to obtain a target sub-feature corresponding to the target text sentence, where the preceding prosodic prompt information is determined based on a sub-feature corresponding to the preceding text sentence in the prosodic fusion feature.

According to embodiments of the present disclosure, the preceding prosodic prompt information includes object prompt speech data characterizing pronunciation content of the specified object, the preceding text sentence, and the sub-feature corresponding to the preceding text sentence.

According to embodiments of the present disclosure, M preceding text sentences are provided, and the preceding prosodic prompt information is determined based on N target preceding text sentences adjacent to the target text sentence among the M preceding text sentences, where M>N≥1, and M and N are integers.

According to embodiments of the present disclosure, the specified pronunciation attribute is determined by performing pronunciation attribute identification on object prompt speech data associated with the specified object.

According to embodiments of the present disclosure, the target speech data acquisition module includes: a speech fusion feature acquisition unit and a denoising unit.

The speech fusion feature acquisition unit is used to fuse the prosodic fusion feature with the specified pronunciation attribute based on an attention mechanism, so as to determine a speech fusion feature.

The denoising unit is used to denoise preset noise data based on the speech fusion feature, so as to obtain the target speech data.

According to embodiments of the present disclosure, the prosodic description text characterizes at least one of the following pronunciation prosodic intentions: an accent attribute intention, an emotion attribute intention, a speech rate attribute intention, or an intonation attribute intention.

FIG. 9 schematically shows a block diagram of an apparatus of training a large model according to embodiments of the present disclosure.

As shown in FIG. 9, an apparatus 900 of training a large model includes: a second receiving module 910, a sample prosodic fusion feature acquisition module 920, and a training module 930.

The second receiving module 910 is used to receive sample prosodic description text, sample speech text, and a labeled prosodic fusion feature, where the sample prosodic description text describes pronunciation prosodic intentions for a plurality of sample text characters in the sample speech text, a labeled sub-feature in the labeled prosodic fusion feature characterizes a pronunciation prosody of a labeled speech segment in labeled speech data with respect to the sample text characters, and the labeled speech data characterizes the sample speech text.

The sample prosodic fusion feature acquisition module 920 is used to perform semantic fusion on the sample prosodic description text and the sample speech text by using the large model, so as to obtain a sample prosodic fusion feature.

The training module 930 is used to train the large model based on a difference between the sample prosodic fusion feature and the labeled prosodic fusion feature, so as to obtain a trained large model.

According to embodiments of the present disclosure, the labeled prosodic fusion feature is determined by processing the labeled speech data through a trained speech encoder, and the trained speech encoder is determined by: performing feature extraction on reference speech data by using a speech encoder, so as to obtain a pre-trained prosodic fusion feature and a pre-trained pronunciation attribute, where the pre-trained pronunciation attribute is associated with a sample object orally expressing the labeled speech data; generating pre-trained speech data based on the pre-trained prosodic fusion feature and the pre-trained pronunciation attribute; and training the speech encoder based on a difference between the pre-trained speech data and the reference speech data, so as to obtain the trained speech encoder.

According to embodiments of the present disclosure, the pre-trained speech data is generated by denoising sample preset noise data through a speech decoder of a speech generation model based on the pre-trained prosodic fusion feature and the pre-trained pronunciation attribute; and the speech generation model further includes the speech encoder; and the training the speech encoder based on a difference between the pre-trained speech data and the reference speech data includes: training the speech encoder and the speech decoder based on the difference between the pre-trained speech data and the reference speech data.

According to embodiments of the present disclosure, the performing feature extraction on reference speech data by using a speech encoder includes: performing the feature fusion on the reference speech data based on an attention mechanism, so as to obtain an initial sample fusion feature; and performing a convolutional downsampling operation on the initial sample fusion feature to obtain the pre-trained prosodic fusion feature.

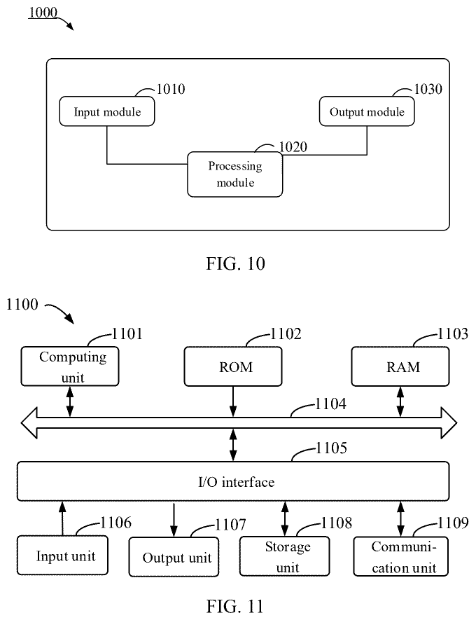

FIG. 10 schematically shows a block diagram of an artificial intelligence agent according to embodiments of the present disclosure.

In embodiments of the present disclosure, as shown in FIG. 10, an AI agent 1000 may include an input module 1010, a processing module 1020, and an output module 1030.

The input module 1010 is used to receive input information.

The processing module 1020 is used to determine a target task based on the input information received by the input module, determine a large model based on the target task, and perform the method of generating speech data based on a large model provided in embodiments of the present disclosure by invoking the large model or perform the method of training a large model provided in embodiments of the present disclosure by invoking the large model, so as to obtain output information.

The output module 1030 is used to output the output information obtained by the processing module.

According to embodiments of the present disclosure, the input module 1010 is responsible for receiving or perceiving information such as a query, a request, an instruction, a signal, or data from the outside world (e.g., users or external environments) and converting it into a format understandable and processable by the AI agent 1000. The input module 1010 is a primary link for the AI agent 1000 to interact with the outside world, which enables the AI agent 1000 to efficiently and accurately obtain necessary “sensory” information from the outside world and respond to such information.

In an example, the input module 1010 may input the prosodic description text, the speech text, etc., as described above.

In an example, the processing module 1020 is a core support for the capability of the AI agent 1000 to process a complex task. The processing module 1020 may perform the method of generating speech data based on a large model or the method of training a large model as described above.

In an example, the performance of the processing module 1020 is closely associated with the large model on which the AI agent 1000 is based. In order to fully exert the capability of the large model, an internal structure of the processing module 1020 may be designed to be highly configurable and extensible, so as to meet various types of tasks and requirements in real-world scenarios.

In an example, after the AI agent 1000 acquires the prosodic description text and the speech text, the processing module 1020 may process the prosodic description text and the speech text using the large model, output a prosodic fusion feature, process the prosodic fusion feature and a specified pronunciation attribute by invoking the large model, so as to obtain target speech data, and transmit the target speech data to the output module 1030.

It may be understood that, although a large language model has excellent language understanding and generation capabilities, like humans, it may only solve a limited number of tasks without any tools. When the AI agent 1000 is endowed with a tool invocation capability, it may perform tasks such as a mathematical calculation with a calculator, data analysis with Python, and weather forecasting with a search engine.

In an example, the output module 1030 may output the target speech data or the trained large model as described above.

The AI agent 1000 according to embodiments of the present disclosure may simply and effectively improve a degree of intelligence and improve flexibility and versatility.

According to embodiments of the present disclosure, the present disclosure further provides an electronic device, a readable storage medium, and a computer program product.

According to embodiments of the present disclosure, an electronic device is provided, including: at least one processor; and a memory communicatively connected to the at least one processor; where the memory stores instructions executable by the at least one processor, and the instructions, when executed by the at least one processor, are used to cause the at least one processor to implement the methods as described above.

According to an embodiment of the present disclosure, a non-transitory computer-readable storage medium having computer instructions stored therein is provided, where computer instructions are used to cause a computer to implement the methods as described above.

According to embodiments of the present disclosure, a computer program product containing a computer program is provided, where the computer program, when executed by a processor, is used to cause the processor to implement the methods as described above.

FIG. 11 shows a schematic block diagram of an exemplary electronic device for implementing a method of generating speech data based on a large model and a method of training a large model according to embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 11, an electronic device 1100 includes a computing unit 1101 which may perform various appropriate actions and processes according to a computer program stored in a read only memory (ROM) 1102 or a computer program loaded from a storage unit 1108 into a random access memory (RAM) 1103. In the RAM 1103, various programs and data necessary for an operation of the electronic device 1100 may also be stored. The computing unit 1101, the ROM 1102 and the RAM 1103 are connected to each other through a bus 1104. An input/output (I/O) interface 1105 is also connected to the bus 1104.

A plurality of components in the electronic device 1100 are connected to the I/O interface 1105, including: an input unit 1106, such as a keyboard, or a mouse; an output unit 1107, such as displays or speakers of various types; a storage unit 1108, such as a disk, or an optical disc; and a communication unit 1109, such as a network card, a modem, or a wireless communication transceiver. The communication unit 1109 allows the electronic device 1100 to exchange information/data with other devices through a computer network such as Internet and/or various telecommunication networks.

The computing unit 1101 may be various general-purpose and/or dedicated processing assemblies having processing and computing capabilities. Some examples of the computing units 1101 include, but are not limited to, a central processing unit (CPU), a graphics processing unit (GPU), various dedicated artificial intelligence (AI) computing chips, various computing units that run machine learning model algorithms, a digital signal processing processor (DSP), and any suitable processor, controller, microcontroller, etc. The computing unit 1101 executes various methods and steps as described above, such as the method of generating speech data based on a large model or the method of training a large model. For example, in some embodiments, the method of generating speech data based on a large model or the method of training a large model may be implemented as a computer software program which is tangibly embodied in a machine-readable medium, such as the storage unit 1108. In some embodiments, the computer program may be partially or entirely loaded and/or installed in the electronic device 1100 via the ROM 1102 and/or the communication unit 1109. The computer program, when loaded in the RAM 1103 and executed by the computing unit 1101, may execute one or more steps in the method of generating speech data based on a large model or the method of training a large model as described above. Alternatively, in other embodiments, the computing unit 1101 may be configured to perform the method of generating speech data based on a large model or the method of training a large model by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the methods of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (e.g., a CRT (cathode ray tube) or LCD (liquid crystal display) monitor) for displaying information to the user, and a keyboard and a pointing device (e.g., a mouse or a trackball) through which the user may provide the input to the computer. Other types of devices may also be used to provide interaction with the user. For example, a feedback provided to the user may be any form of sensory feedback (e.g., visual feedback, auditory feedback, or tactile feedback), and the input from the user may be received in any form (including acoustic input, voice input or tactile input).

The systems and technologies described herein may be implemented in a computing system including back-end components (e.g., a data server), or a computing system including middleware components (e.g., an application server), or a computing system including front-end components (e.g., a user computer having a graphical user interface or web browser through which the user may interact with the implementation of the system and technology described herein), or a computing system including any combination of such back-end components, middleware components or front-end components. The components of the system may be connected to each other by digital data communication (e.g., a communication network) in any form or through any medium. Examples of the communication network include a local area network (LAN), a wide area network (WAN), and the Internet.

The computer system may include a client and a server. The client and the server are generally far away from each other and usually interact through a communication network. The relationship between the client and the server is generated through computer programs running on the corresponding computers and having a client-server relationship with each other. The server may be a cloud server, a server of a distributed system, or a server combined with a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be realized. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method of generating speech data based on a large model, comprising:
receiving prosodic description text and speech text, wherein the prosodic description text describes pronunciation prosodic intentions for a plurality of text characters in the speech text;
performing semantic fusion on the prosodic description text and the speech text by using the large model, so as to obtain a prosodic fusion feature, wherein a sub-feature in the prosodic fusion feature characterizes a pronunciation prosody of a speech segment with respect to the text characters, and to-be-generated target speech data comprises the speech segment; and
generating, based on the prosodic fusion feature and a specified pronunciation attribute associated with a specified object, target speech data characterizing that the specified object pronounces in accordance with the pronunciation prosodic intentions and corresponding to the speech text.

2. The method according to claim 1, wherein the performing semantic fusion on the prosodic description text and the speech text by using the large model comprises:
performing, based on the prosodic description text as prompt information, semantic fusion on the pronunciation prosodic intentions associated with the text characters and at least one text character by using the large model, so as to obtain a plurality of sequentially arranged sub-features.

3. The method according to claim 2, wherein the performing, based on the prosodic description text as prompt information, semantic fusion on the pronunciation prosodic intentions associated with the text characters and at least one text character by using the large model comprises: by using the large model,
determining, from the speech text, specified text characters respectively matching the pronunciation prosodic intentions characterized by the prosodic description text by performing semantic understanding on the prosodic description text; and
performing semantic fusion on the pronunciation prosodic intentions respectively corresponding to the specified text characters and the specified text characters in the speech text, so as to output the sub-features associated with the specified text characters.

4. The method according to claim 1, wherein the speech text comprises a target text sentence and a preceding text sentence arranged before the target text sentence; and
wherein the performing semantic fusion on the prosodic description text and the speech text by using the large model comprises:
performing, based on preceding prosodic prompt information corresponding to the target text sentence, semantic fusion on the prosodic description text and the target text sentence by using the large model, so as to obtain a target sub-feature corresponding to the target text sentence, wherein the preceding prosodic prompt information is determined based on a sub-feature corresponding to the preceding text sentence in the prosodic fusion feature.

5. The method according to claim 4, wherein the preceding prosodic prompt information comprises object prompt speech data characterizing pronunciation content of the specified object, the preceding text sentence, and the sub-feature corresponding to the preceding text sentence.

6. The method according to claim 4, wherein M preceding text sentences are provided, and the preceding prosodic prompt information is determined based on N target preceding text sentences adjacent to the target text sentence among the M preceding text sentences, wherein M>N≥1, and M and N are integers.

7. The method according to claim 1, wherein the specified pronunciation attribute is determined by performing pronunciation attribute identification on object prompt speech data associated with the specified object.

8. The method according to claim 1, wherein the generating, based on the prosodic fusion feature and a specified pronunciation attribute associated with a specified object, target speech data characterizing that the specified object pronounces in accordance with the pronunciation prosodic intentions and corresponding to the speech text comprises:
fusing the prosodic fusion feature with the specified pronunciation attribute based on an attention mechanism, so as to determine a speech fusion feature; and
denoising preset noise data based on the speech fusion feature, so as to obtain the target speech data.

9. The method according to claim 1, wherein the prosodic description text characterizes at least one of following pronunciation prosodic intentions:
an accent attribute intention, an emotion attribute intention, a speech rate attribute intention, or an intonation attribute intention.

10. A method of training a large model, comprising:
receiving sample prosodic description text, sample speech text, and a labeled prosodic fusion feature, wherein the sample prosodic description text describes pronunciation prosodic intentions for a plurality of sample text characters in the sample speech text, a labeled sub-feature in the labeled prosodic fusion feature characterizes a pronunciation prosody of a labeled speech segment in labeled speech data with respect to the sample text characters, and the labeled speech data characterizes the sample speech text;
performing semantic fusion on the sample prosodic description text and the sample speech text by using the large model, so as to obtain a sample prosodic fusion feature; and
training the large model based on a difference between the sample prosodic fusion feature and the labeled prosodic fusion feature, so as to obtain a trained large model.

11. The method according to claim 10, wherein the labeled prosodic fusion feature is determined by processing the labeled speech data through a trained speech encoder, and the trained speech encoder is determined by:
performing feature extraction on reference speech data by using a speech encoder, so as to obtain a pre-trained prosodic fusion feature and a pre-trained pronunciation attribute, wherein the pre-trained pronunciation attribute is associated with a sample object orally expressing the labeled speech data;
generating pre-trained speech data based on the pre-trained prosodic fusion feature and the pre-trained pronunciation attribute; and
training the speech encoder based on a difference between the pre-trained speech data and the reference speech data, so as to obtain the trained speech encoder.

12. The method according to claim 11, wherein the pre-trained speech data is generated by denoising sample preset noise data through a speech decoder of a speech generation model based on the pre-trained prosodic fusion feature and the pre-trained pronunciation attribute; and
wherein the speech generation model further comprises the speech encoder; and the training the speech encoder based on a difference between the pre-trained speech data and the reference speech data comprises:
training the speech encoder and the speech decoder based on the difference between the pre-trained speech data and the reference speech data.

13. The method according to claim 11, wherein the performing feature extraction on reference speech data by using a speech encoder comprises:
performing the feature fusion on the reference speech data based on an attention mechanism, so as to obtain an initial sample fusion feature; and
performing a convolutional downsampling operation on the initial sample fusion feature to obtain the pre-trained prosodic fusion feature.

14. An artificial intelligence agent, comprising:
an input module configured to receive input information;
a processing module configured to determine a target task based on the input information received by the input module, determine a large model based on the target task, and perform the method according to claim 1 by invoking the large model, so as to obtain output information; and
an output module configured to output the output information obtained by the processing module.

15. An artificial intelligence agent, comprising:
an input module configured to receive input information;
a processing module configured to determine a target task based on the input information received by the input module, determine a large model based on the target task, and perform the method according to claim 10 by invoking the large model, so as to obtain output information; and
an output module configured to output the output information obtained by the processing module.

16. An electronic device, comprising:
at least one processor; and
a memory communicatively connected to the at least one processor,
wherein the memory stores instructions executable by the at least one processor, and the instructions, when executed by the at least one processor, are configured to cause the at least one processor to:
receive prosodic description text and speech text, wherein the prosodic description text describes pronunciation prosodic intentions for a plurality of text characters in the speech text;
perform semantic fusion on the prosodic description text and the speech text by using the large model, so as to obtain a prosodic fusion feature, wherein a sub-feature in the prosodic fusion feature characterizes a pronunciation prosody of a speech segment with respect to the text characters, and to-be-generated target speech data comprises the speech segment; and
generate, based on the prosodic fusion feature and a specified pronunciation attribute associated with a specified object, target speech data characterizing that the specified object pronounces in accordance with the pronunciation prosodic intentions and corresponding to the speech text.

17. The electronic device according to claim 16, wherein the at least one professor is further configured to:
perform, based on the prosodic description text as prompt information, semantic fusion on the pronunciation prosodic intentions associated with the text characters and at least one text character by using the large model, so as to obtain a plurality of sequentially arranged sub-features.

18. An electronic device, comprising:
at least one processor; and
a memory communicatively connected to the at least one processor,
wherein the memory stores instructions executable by the at least one processor, and the instructions, when executed by the at least one processor, are configured to cause the at least one processor to implement the method according to claim 10.

19. A non-transitory computer-readable storage medium having computer instructions stored therein, wherein the computer instructions, when executed by a processor, are configured to cause a computer to implement the method according to claim 1.

20. A non-transitory computer-readable storage medium having computer instructions stored therein, wherein the computer instructions, when executed by a processor, are configured to cause a computer to implement the method according to claim 10.
